(19) United States
(12) Patent Application Publication
(10) Pub. No.: US 2002/0083197 A1
(43) Pub. Date: Jun. 27, 2002

(54) System and method for managing micro-mobility service in IP networks and computer-readable medium storing program for implementing the same

(76) Inventors: Heeyoung Jung, Taejon (KR); Yong Jin Kim, Taejon (KR)

Correspondence Address: JACOBSON HOLMAN, PLLC, PROFESSIONAL LIMITED LIABILITY COMPANY, 400 Seventh Street, N.W., Washington, DC, 20004, US

(21) Appl. No.: 10/025,800

(22) Filed: Dec. 26, 2001

(30) Foreign Application Priority Data
Dec. 26, 2000 (KR) 2000-82264

(51) Int. Cl. G06F 15/173

(52) U.S. Cl. 709/238

(57) ABSTRACT

Disclosed are a system and method for supporting a fast hand-off in internet protocol networks and simplify a micro-mobility management, and a computer-readable medium storing a program for implementing the above method therein. The system includes a gateway for managing interfacing with Internet and location information of a mobile host; a plurality of base stations with a hierarchical architecture, which has a switching function and connects the gateway with the mobile host; and a database for storing the location information of the mobile host. The gateway interfacing with Internet manages the database for storing the location information of the mobile host, and adds additional header data to packet data received for the data transmission to the mobile host, wherein the additional header data represents the location information of the mobile host.

### FIELD OF THE INVENTION

The present invention relates to a system and method for providing a micro-mobility service in Internet protocol networks and a computer-readable medium storing a program for implementing the above method therein. More particularly, the present invention relates to a system and method for using a hierarchical architecture of base stations at a local area network in a micro-mobility management for supporting a fast hand-off in the Internet protocol networks, to thereby simplify a local mobility management, and implement the system at low cost, and a computer-readable medium storing a program for implementing the above method therein.

### DESCRIPTION OF THE PRIOR ART

As Internet acceleratedly advances, a wireless network as well as a typical wired network is showing an increased tendency to use an Internet protocol (hereinafter, referred to as “IP”). Hence, in a 3rd generation partnership project (3GPP) and 3rd generation partnership project 2(3GPP2), which take the lead of the standardization of typical mobile communications, a standardization of an All-IP network that uses the IP during the transmission of data and signaling is being promoted.

When an IP service is provided to a user in mobile wireless networks, the user is identified by the IP address. In this case, a mobility management for a moving user who uses the IP is of importance.

A mobility management approach used in the conventional representative IP network includes a mobile IP by Internet Engineering Task Force (IETF).

Since, however, the mobile IP have been designed for slow mobility in a global area, it suffers from drawbacks that it has an increased load in backbone networks due to data delay, frequent signaling, and therefore it is difficult to apply to an application which has a fast mobility and requests a real time service in the future.

To overcome the foregoing problem, a local tunneling approach is proposed which has a structure having a gateway foreign agent (GFA) that acts as a gateway and operates as a home agent (HA) on a foreign agent (FA) at the upper part, and a hierarchical foreign agent (FA) at the lower part, wherein a mobility between foreign agents in a local area is managed by the GFA and a mobility in other than the local area is managed by mobile IPs.

However, the approach suffers from drawbacks that a location registration of mobile host should be performed on all of the foreign agents within all areas, and the implementation of the local tunneling approach is complex due to a frequent tunneling between the foreign agents.

To overcome the complexity of the local tunneling approach, a cellular IP is proposed, which is considered as a powerful scheme for managing the micro-mobility in a current IP network.

In the cellular IP, the connect to Internet is performed by a gateway, and a plurality of nodes connected to a stage subsequent to the gateway in a wire is coupled with one another in a flat fashion, wherein each of the nodes includes a cache for managing the mobility of the mobile host. The cache includes a paging cache for managing an idle mobile host having none of data to be transmitted and received, and an active routing cache having data to be transmitted and received. The update of the cache is performed with a location registration message and location update message or packet data, which is transferred from the mobile host through the Internet. Thus, the cellular IP approach may be easily implemented compared with the local tunneling approach.

Unfortunately, the cellular IP approach suffers from a drawback that a plurality of nodes has to include and manage the cache and a load of control message for updating the cache is large.

### SUMMARY OF THE INVENTION

It is, therefore, an object of the present invention to provide a system and method for supporting a fast hand-off in internet protocol networks and simplify a micro-mobility management.

It is another object of the present invention to provide a computer-readable medium storing a program for implementing the above method therein.

In the present invention, although the cellular IP architecture, which connects the local network as a whole through the use of a gateway, is employed to facilitate the implementation of the present invention, each node of the lower part of the gateway has a hierarchical architecture, and a location management for the mobile host is processed by the gateway. Each node also has a simple switching function to facilitate the mobility management within a local area compared with the conventional approach.

In accordance with one aspect of the present invention, there is provided a system for managing a mobility service in internet protocol networks, comprising: a gateway means for managing interfacing with Internet and location information of a mobile host; a transfer means with a plurality of hierarchical nodes and a switching function, for connecting the gateway means with the mobile host, where each of the nodes includes a multiplicity of base stations; and a storage means for storing the location information of the mobile host.

In accordance with another aspect of the present invention, there is provided a method for managing a mobility service in internet protocol networks, the method comprising the steps of: (a) receiving location registration message or location update message, which are generated responsive to the movement of a mobile host, through a node having a hierarchical architecture; (b) storing the received location registration message or the received location update message in a database; and (c) transferring a packet to the location of the mobile host contained in the location registration message or the location update message, through the node having the hierarchical architecture.

In accordance with yet another aspect of the present invention, there is provided a computer-readable medium storing a program, in a mobility management system with a mass storage processor, for implementing the functions of receiving location registration message or location update message, which are generated responsive to the movement of a mobile host, through a node having a hierarchical architecture; storing the received location registration message or the received location update message in a database; and transferring a packet to the location of the mobile host contained in the location registration message or the location update message, through the node having the hierarchical architecture.

### BRIEF DESCRIPTION OF THE DRAWINGS

The above and other objects and features of the present invention will become apparent from the following description of the preferred embodiments given in conjunction with the accompanying drawings, in which:

FIG. 1 is a pictorial representation of micro-mobility management architecture in accordance with a preferred embodiment of the present invention;

FIGS. 2A to 2C show formats of a location registration message and a acknowledge message, transmission data and reception data in accordance with the present invention;

FIG. 3 is a pictorial representation illustrating the location registration procedure or the location update procedure of the mobile host in micro-mobility management architecture in accordance with another embodiment of the present invention;

FIG. 4 is a pictorial representation illustrating the data transmission procedure of the mobile host in a micro-mobility management architecture in accordance with an embodiment of the present invention;

FIG. 5 is a pictorial representation illustrating the data reception procedure of the mobile host in micro-mobility management architecture in accordance with an embodiment of the present invention; and

FIG. 6 is a flow chart illustrating a handover method of a mobile host in layer 2 in accordance with the present invention.

### DETAILED DESCRIPTION OF THE PREFERRED EMBODIMENTS

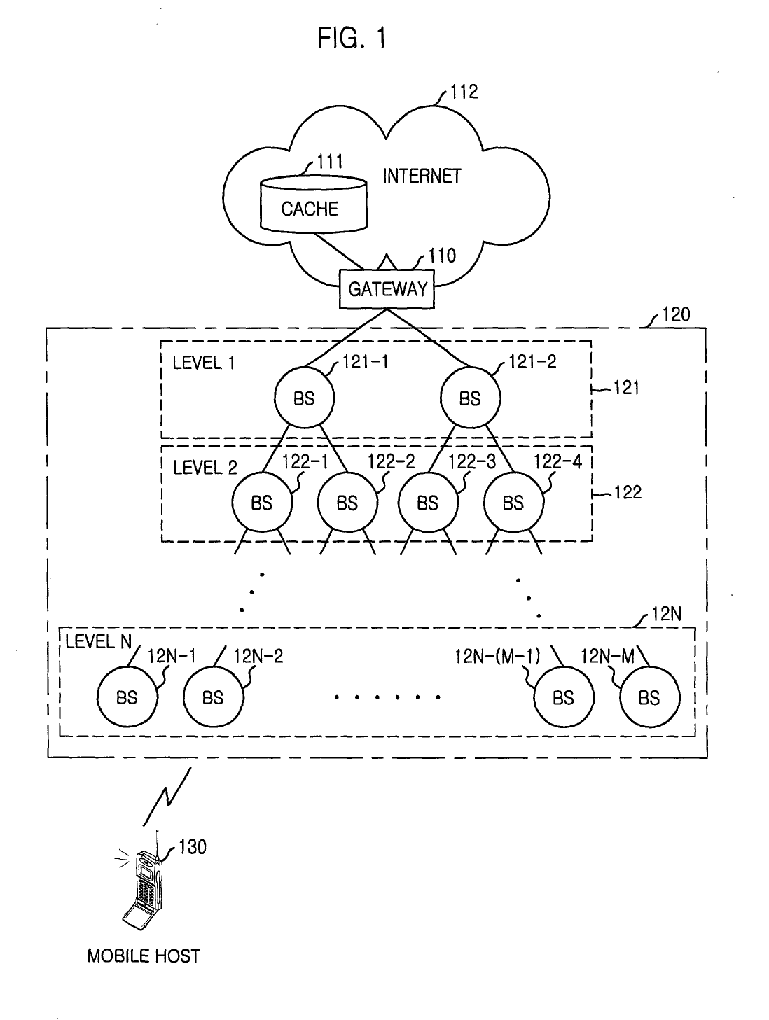

Referring to FIG. 1, there is a pictorial representation of a micro-mobility management architecture in accordance with a preferred embodiment of the present invention. As shown in FIG. 1, the architecture of the present invention includes a gateway (GW) 110, a base station (BS) block 120 having a plurality of levels wherein each level (node) has a multiplicity of base stations (BSs), a hierarchical structure, a mobile host 130, and a cache 111 coupled with the gateway 110.

A description will be made as to procedures of a location registration, packet reception, location update, and packet transfer in the micro-mobility management architecture of the present invention.

Firstly, in the procedure of registering a location of the mobile host 130, when the mobile host 130 enters into a new domain, a node of the mobile node 130 recognizes that it entered into a new service area based on a domain identification (ID) and ID of the base station 12N−1 of the BS block 120, which are contained in a beacon signal transmitted thereto from the base station 12N−1 to which the node belongs; and transmits the node's ID and location registration message having the ID of the base station 12N−1 to the base station 12N−1 that services the mobile host 130.

In response to the location registration message, the base station 12N−1 transmits the message to a base station, e.g., 122-1 of the BS block 120 without any handling thereon. Such procedure is continuously performed until the location registration message reaches to the gateway 110.

The base station 120 having the hierarchical architecture allows each base station to simply transfer data or message to be directed to the gateway 110 to an upper base station without any handling thereon, and perform a simple switching function of, e.g., 2 by 2, on data to be directed to the lower hierarchical, to thereby easily implement the architecture compared with the conventional approach.

The gateway 110, responsive to the location registration message received from the base station, e.g., 121-1 of the BS block 120, writes the ID and the location information of the mobile host 130 in the cache 111, transmits an acknowledge message to the mobile host, and then terminates the location registration procedure for the mobile host 130.

Next, in the procedure which the mobile host 130 receives a packet through the Internet 112, the gateway 110 adds an additional header of N bit(s) to the packet through the use of the location information written in the cache 111, and transmits the added header data to the base station 121-1 of the first node, wherein the header represents the location information of the mobile host 130.

The base station 121-1 uses a least significant bit, i.e., Nth bit of the added header data to switch it to the base station 122-1 of the second node lower than the first node for the transfer thereof.

The base station 122-1 uses a (N−1)th bit of the added header data to switch the packet, and transfers the packet to a base station of a subsequent level. By repeating the above process, the packet is transferred to the base station 12N−1 of the Nth node as shown in FIG. 1.

Specifically, the aforementioned procedure is continuously performed until the packet is transferred to the base station 12N−1, which is servicing the mobile host 130, i.e., the (N−1)th bit of the added header data (the base station of the Nth node) is switched. The base station 12N−1that is servicing the mobile host 130 forwards the received packet to the mobile host 130 through a wireless network.

A description will be made as to the procedure of updating the location of the mobile host 130, when the mobile host 130 moves to another service area.

Upon the movement of the mobile host 130 to another area, if the base station 12N−1 which is servicing the mobile host 130 is changed, the mobile host 130 determines information of a new base station, e.g., 12N−M based on a beacon transmitted thereto from the new base station 12N−M and recognizes that it is therein.

If the current state is active and being transmitting, the transmission data is transmitted to the new base station 12N−M. On the contrary, if the current state is active and being received or idle, the location registration message is transmitted to the gateway 110, and the terminates the handoff procedure. In order to prevent the packets from being lost during the handoff, the base station or the gateway can perform buffering of the packets.

Thereafter, the mobile host 130 transmits the location update message to the base station, which is servicing the mobile host 130.

The base station 12N−M transfers the location update message to a base station, e.g., 122-4 of the upper node. Such procedure is continuously repeated until the message reaches to the gateway 110 in an identical manner as for the location registration message.

Upon the reception of the location update message, the gateway 110 updates the location information of the mobile host 130 stored in the cache 111 with the message.

A description will be made as to the procedure of transmitting the packet to the Internet 112 from the mobile host 130. The transmission of the packet to the Internet 112 is performed through the gateway 110 in an identical manner as for the location registration message and the location update message. The update of the cache 111 of the gateway 110 may be performed with the location registration message or the location update message.

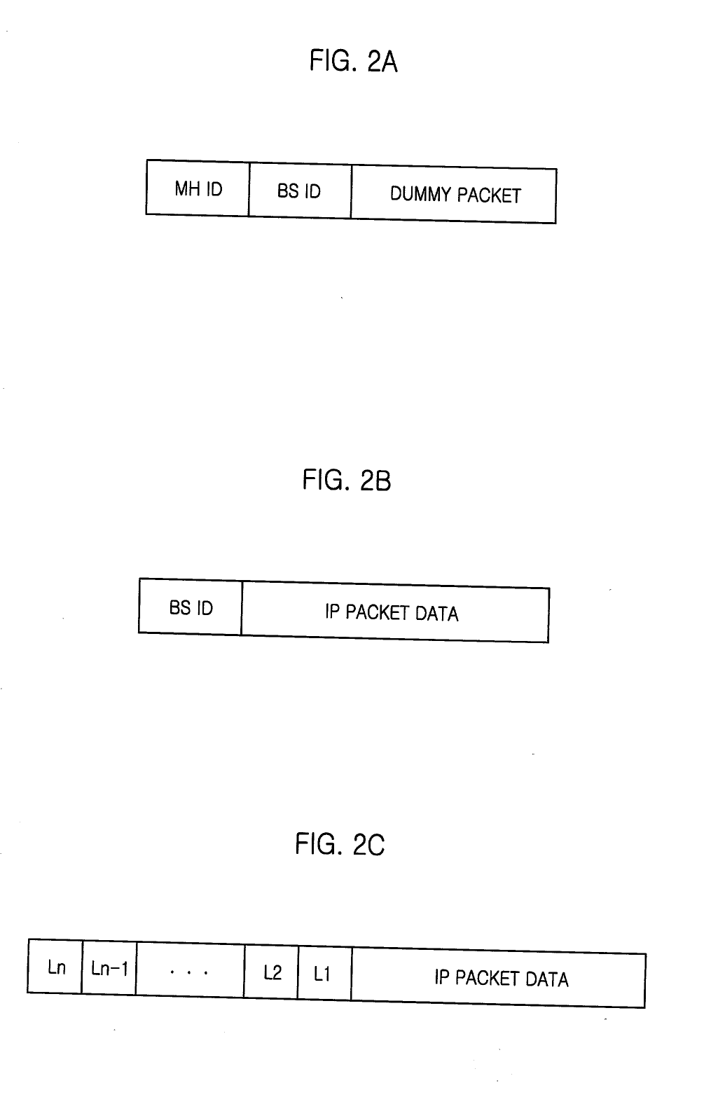

FIGS. 2A to 2C show formats of a location registration message and a acknowledge message, transmission data and reception data in accordance with the present invention.

In the present invention, the formats of the messages are similar as those of the conventional IP data, a different header is added to front of the IP header.

Referring to FIG. 2A, MH ID represents an identification (ID) of the mobile host and BS ID an identification (ID) of the base station (BS). A dummy packet includes no information, which is used for additional information.

Referring to FIG. 2B, BS ID represents an identification (ID) of the base station servicing the mobile host and IP Packet Data does the IP Packet Data to be transmitted. The BS ID information added to the IP packet data is used for updating cache information in the gateway.

Referring to FIG. 2C, L1, L2, . . . , Ln−1, and Ln represent switching information in layers 1 to n, respectively. IP Packet Data represents the IP Packet Data to be received. Each of the base stations transmits the data to the final destination, i.e., the mobile host by switching the received data in accordance with bits of a corresponding header.

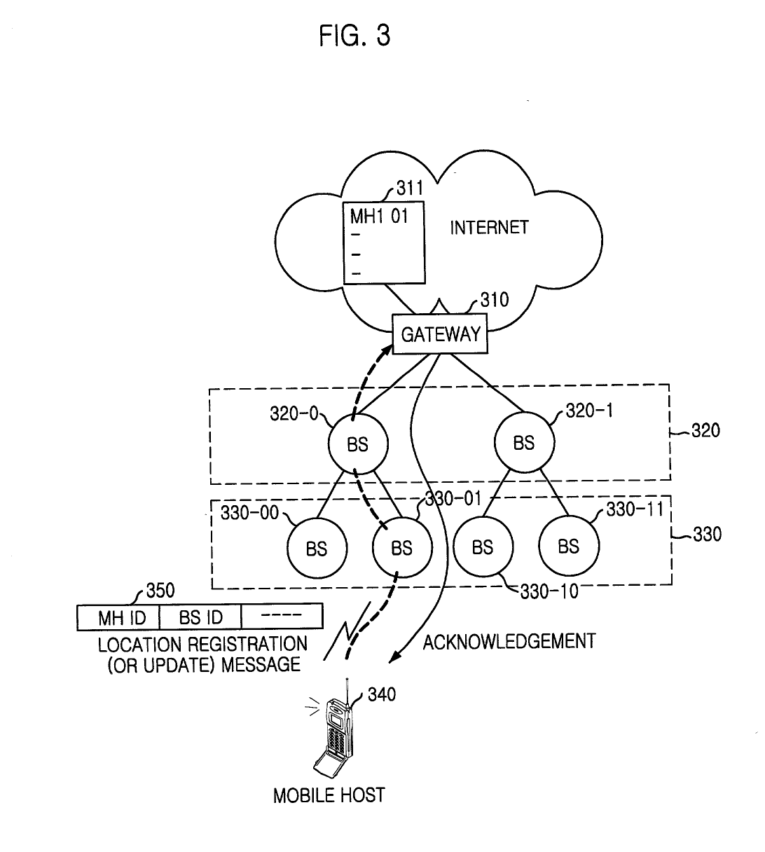

FIG. 3 is a pictorial representation illustrating the location registration procedure or the location update procedure of the mobile host in the micro-mobility management architecture in accordance with an embodiment of the present invention. In FIG. 3, two levels of base stations are shown.

The architecture of the present invention shown in FIG. 3 includes a gateway 310, a location management database 311 of the gateway 310, a node 320 of the first level, a node 330 of the second level, and location registration message 350. The location registration message 350 may be location update message. The nodes have a plurality of base stations.

A description will be made as to the location registration procedure of the mobile host 340 in the micro-mobility management architecture of the present invention with reference to FIG. 3.

Referring to FIG. 3, each base station in each node periodically broadcasts a node identification representing their own identification and an area identification representing an identification of the gateway.

The mobile host 340 determines that it entered within a new local management area based on a domain identification contained in a beacon broadcasted from each base station, and transmits its identification and the location registration message 350 containing the identification of the base station, e.g., 330-01 in the node 330 to the base station 330-01 of the second level for the transfer of them to the gateway 310.

The base station 330-01 transmits the location registration message 350 received from the mobile host 340 through a wireless interface to a base station, e.g., 320-0 of the upper node (i.e., node 320). It should be noted that, during the location registration (or update) of the mobile host 340, each node simply transfers the location registration message or the location update message to the base station of the upper level, without any data processing thereon.

The base station 320-0 transmits the location registration message or the location update message 350 to the gateway 310.

Upon the reception of the location registration message or the location update message from the base station 320-0, the gateway 310 registers the location information of mobile host 340 in the location management database 311. Wherein the location management database 311 of the gateway 310 has the identification and a current location 01 of the mobile host 340.

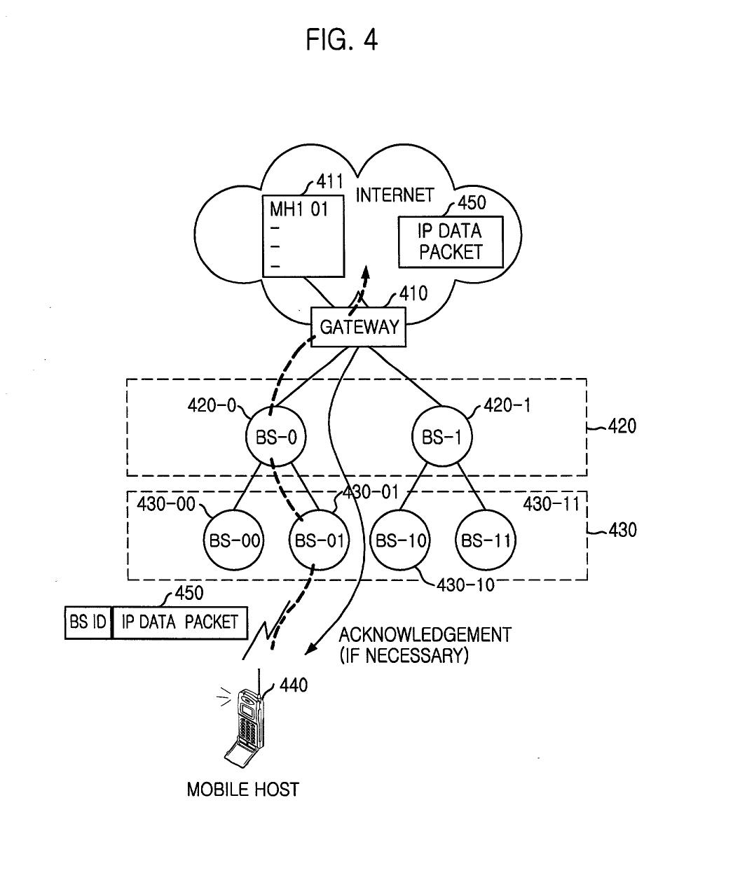

FIG. 4 is a pictorial representation illustrating the data transmission procedure of the mobile host in a micro-mobility management architecture in accordance with an embodiment of the present invention. In FIG. 4, the number of nodes of base station is two.

A description will be made as to the data transmission procedure of the mobile host in the micro-mobility management architecture of the present invention with reference to FIG. 4.

Referring to FIG. 4, the mobile host 440 transmits packet data to be transmitted to the Internet through a base station, e.g., 430-01 in a node 430 that manages the mobile host 440 via a wireless interface.

The base station 430-01 of the second node 430 transmits the packet data received from the mobile host 440 through the wireless interface to a base station, e.g., 420-0 of the upper node 420. It should be noted that, during the data transmission, each node simply transfers the packet data to the base station of the upper level, without any data processing thereon.

The base station 420-0 transmits the received packet data to the gateway 410.

Upon the reception of the packet data from the base station 420-0, the gateway 410 transmits it to the Internet. If the BS ID of the received data is different from the information stored on the cache, the gateway updates the location information and transmits to the mobile host an acknowledge informing the update of the location information.

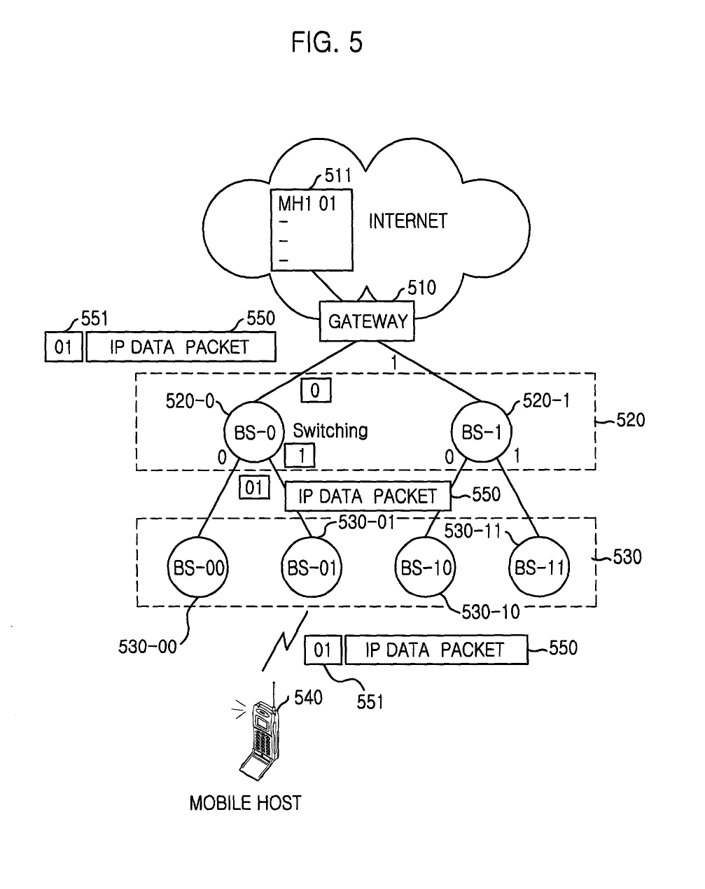

FIG. 5 is a pictorial representation illustrating the data reception procedure of the mobile host in the micro-mobility management architecture in accordance with an embodiment of the present invention. In FIG. 4, the number of nodes of base stations is two.

A description will be made as to the data reception procedure of the mobile host in the micro-mobility management architecture of the present invention with reference to FIG. 5.

As indicated by a dot line in FIG. 5, the packet data to be transmitted to a mobile host 540 via the Internet is reached to a gateway 510.

The gateway 510 retrieves a database 511 thereof to detect a location of the mobile host 540. In this case, if there is no the location information on the mobile host 540 stored in the database 511, the reception of the packet data may be rejected.

Since the gateway 510 recognizes that the mobile host 540 is located in the base station 530-01 of the second node 530, it adds an additional header “1” to the received packet data and forwards it to a base station 520-0 of the upper node 520.

The base station 520-0 of the upper node 520 checks the header of the packet data transmitted thereto from the gateway 510. Responsive to the checked result, i.e., 1, the base station 520-0 switches the packet data to the base station 530-01.

The base station 530-01 transmits the received packet data to the mobile host 540 through a wireless network.

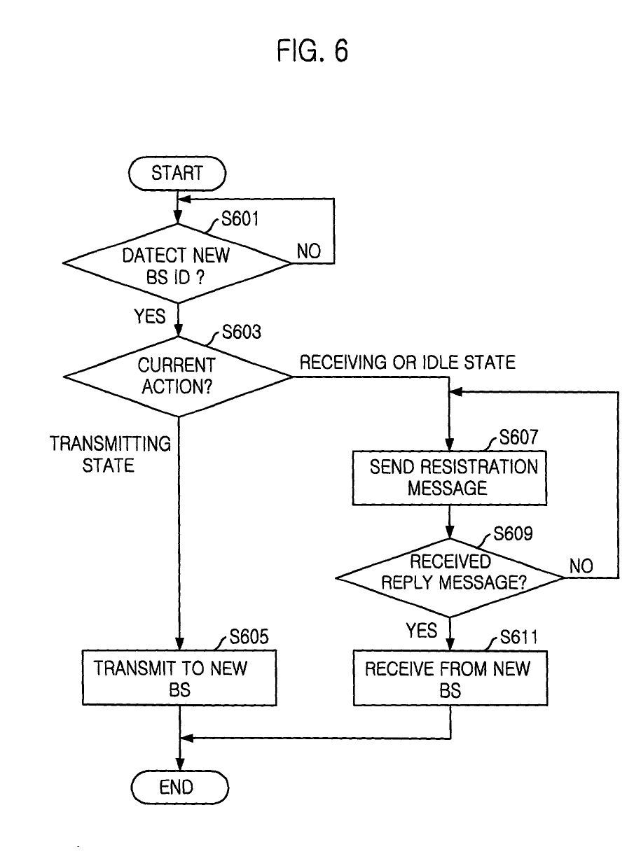

FIG. 6 is a flow chart illustrating a handover method of a mobile host in layer 2 in accordance with the present invention.

When a mobile host detects a new base station from the base stations periodically broadcasted at step S601, and then determines whether its state is on transmission, or idle or on reception at step S603. If the state of the mobile host is on transmission, the mobile host transmits the data to the new base station, and terminates the handoff at step S605. If the state of the mobile host is idle or on reception, the mobile host transmits a location registration message to the gateway at step S607. If the acknowledge is received at step S609, the new base station starts to receive data at step S611, thereby terminating the handoff.

The present invention as mentioned above may be implemented with a program which may be stored in a computer-readable medium such as a random access memory (RAM), a read only memory (ROM), a fixed or flexible disk media, PC Card flash disk memory, tape, or any other storage retrieval device, or any combination of these storage retrieval devices.

As demonstrated above, the present invention uses a hierarchical architecture of base stations and a gateway to thereby allow a micro-mobility management to be simply implemented at a low cost, compared with the conventional approach.

Furthermore, the present invention has a simple control message to thereby make it possible to decrease load requirements due to the control message on a local network, and terminate the control message at the gateway during the movement of a mobile host within the local network, which, in turn, eliminates load requirements to be applied to Internet backbone networks.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A system for managing a mobility service in Internet protocol networks, comprising:
a gateway means for managing interfacing with Internet and location information of a mobile host;
a transfer means with a plurality of hierarchical nodes and a switching function, for connecting the gateway means with the mobile host, where each of the nodes includes a multiplicity of base stations; and
a storage means for storing the location information of the mobile host.

2. The system as recited in claim 1, wherein the gateway means manages the interfacing with Internet and the storage means for managing the location information of the mobile host, and adds additional header data to packet data received for the data transmission to the mobile host, wherein the additional header data represents the location information of the mobile host.

3. The system as recited in claim 2, wherein the transfer means having the plurality of hierarchical nodes and the switching function periodically broadcasts domain identification and an identification of a base station through a beacon.

4. The system as recited in claim 2, wherein the mobile host interfaces with the base station via a wireless network, transmits location registration message to the base station when the mobile host enters into a new domain, and transmits location update message when it moves to a new node within the domain.

5. A method for managing a mobility service in internet protocol networks, the method comprising the steps of:
(a) receiving a location registration message or a location update message, which is generated responsive to a movement of a mobile host, through a node having a hierarchical architecture;
(b) storing the received location registration message or the received location update message in a database; and
(c) transferring a packet to the location of the mobile host contained in the location registration message or the location update message, through the node having the hierarchical architecture.

6. The method as recited in claim 5, wherein the location registration message or the location update message includes an identification of a user and an identification of the base station in which the user locates.

7. A computer-readable medium storing a program, in a mobility management system with a mass storage processor, for implementing the functions of:
receiving location registration message or location update message, which are generated responsive to the movement of a mobile host, through a node having a hierarchical architecture;
storing the received location registration message or the received location update message in a database; and
transferring a packet to the location of the mobile host contained in the location registration message or the location update message, through the node having the hierarchical architecture.
